(19) United States
(12) Patent Application Publication
(10) Pub. No.: US 2013/0327701 A1
(43) Pub. Date: Dec. 12, 2013

(54) SEPARATION MEMBRANE AND WATER TREATMENT DEVICE INCLUDING A SEPARATION MEMBRANE

(71) Applicant: SAMSUNG ELECTRONICS CO., LTD., Suwon-Si (KR)

(72) Inventors: Jung Im HAN, Yongin-si (KR); Sung Soo HAN, Hwaseong-si (KR); Soon Chul KWON, Hwaseong-si (KR); Ho-Bum PARK, Seoul (KR); Young Hoon CHO, Seoul (KR)

(73) Assignee: IUCF-HYU (Industry-university Cooperation Foundation Hanyang University), Seoul (KR)

(21) Appl. No.: 13/912,495

(22) Filed: Jun. 7, 2013

(30) Foreign Application Priority Data
Jun. 8, 2012 (KR) 10-2012-0061456

(51) Int. Cl. B01D 71/12; B01D 69/10

(52) U.S. Cl. CPC B01D 71/12; B01D 69/10
USPC 210/490; 536/69; 210/500.27; 210/489

(57) ABSTRACT

A separation membrane including a polymer having a structural unit represented by the following Chemical Formula 1, and a water treatment device including a separation membrane, are useful for desalination.

### CROSS-REFERENCE TO RELATED APPLICATION

This application claims the benefit of priority under 35 U.S.C. §119 from Korean Patent Application No. 10-2012-0061456 filed in the Korean Intellectual Property Office on Jun. 8, 2012, the entire contents of which are incorporated herein by reference.

### BACKGROUND

1. Field

The present disclosure relates to a separation membrane and a water treatment device including the separation membrane.

2. Description of the Related Art

In order to acquire fresh water, or gray water, from sea water, or sewage and waste water, floating or dissolved components should be removed in conformity with the standards for drinking water. At present, reverse osmosis is widely used as a water treatment method for desalinating, or making gray water out of sea water, or sewage and waste water. According to the water treatment method using a reverse osmotic membrane, a pressure corresponding to an osmotic pressure caused by a dissolved component is applied to raw water to separate the dissolved component, such as a base (e.g., NaCl), from the raw water. For example, when the concentration of the base dissolved in sea water ranges from about 30,000 to about 45,000 ppm, the osmotic pressure caused by the concentration ranges from about 20 atm to about 30 atm. Therefore, a pressure of about 20 atm to about 30 atm or higher is applied to the raw water to produce fresh water from the raw water.

On the other hand, a forward osmosis process is economical compared with the reverse osmosis process, because the forward osmosis process does not require applying a pressure, but instead uses a natural osmosis phenomenon. In the forward osmosis process, the chemical characteristics of a separation membrane are important, as is the structure of the separation membrane. In the reverse osmosis process, because water passes through a separation membrane by a pressure, the chemical properties of the separation membrane do not affect the permeated water amount much. However, in the forward osmosis process, because the water spontaneously permeates a separation membrane due to the osmotic pressure difference, the hydrophilicity of the separation membrane significantly affects the flux of water permeated through the membrane. In either a reverse or forward osmosis process, a separation membrane is required to accomplish a high salt rejection rate and high water permeability in a large amount to perform commercially massive desalination and to be used for a sea water desalination device. Accordingly, a separation membrane having a high salt rejection rate and high water permeability is required.

### SUMMARY

A separation membrane having high water permeability and an improved salt rejection rate is provided.

A water treatment device including the separation membrane is also provided.

In one example embodiment, a separation membrane includes a polymer having a structural unit represented by the following Chemical Formula 1:

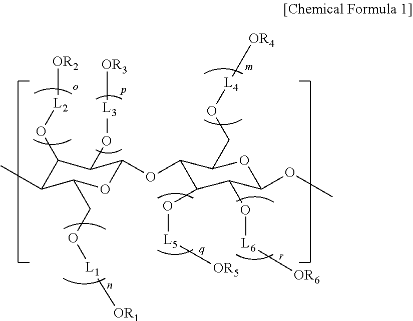

in the above Chemical Formula 1,

R₁ to R₆ are independently one selected from hydrogen, a substituted or unsubstituted C1 to C30 alkyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C6 to C30 heteroaryl group, a substituted or unsubstituted C7 to C30 alkylaryl group, a substituted or unsubstituted C7 to C30 arylalkyl group, and a —(C═O)R₇ group,

wherein, R₇ is one selected from the substituted or unsubstituted C1 to C30 alkyl group, the substituted or unsubstituted C3 to C30 cycloalkyl group, the substituted or unsubstituted C3 to C30 heterocycloalkyl group, the substituted or unsubstituted C6 to C30 aryl group, the substituted or unsubstituted C6 to C30 heteroaryl group, the substituted or unsubstituted C7 to C30 alkylaryl group, and the substituted or unsubstituted C7 to C30 arylalkyl group,

provided that at least one of R₁ to R₃ and at least one of R₄ to R₆ are the same or different, and are the —(C═O)R₇ group, and

provided that at least one of R₁ to R₃ and at least one of R₄ to R₆ are the same or different, and are one selected from the substituted or unsubstituted C1 to C30 alkyl group, the substituted or unsubstituted C3 to C30 cycloalkyl group, the substituted or unsubstituted C3 to C30 heterocycloalkyl group, the substituted or unsubstituted C6 to C30 aryl group, the substituted or unsubstituted C3 to C30 heteroaryl group, the substituted or unsubstituted C7 to C30 alkylaryl group, and the substituted or unsubstituted C7 to C30 arylalkyl group,

L₁ to L₆ are independently one selected from a substituted or unsubstituted C1 to C30 alkylene group, a substituted or unsubstituted C3 to C30 cycloalkylene group, a substituted or unsubstituted C3 to C30 heterocycloalkylene group, a substituted or unsubstituted C6 to C30 arylene group, a substituted or unsubstituted C6 to C30 heteroarylene group, a substituted or unsubstituted C7 to C30 alkylarylene group, and a substituted or unsubstituted C7 to C30 arylalkylene group,

n and m are independently integers ranging from 0 to 150,

o, p, q, and r are independently integers ranging from 0 to 100, and

the polymer has a DS (degree of substitution) of the —(C═O)R₇ group equal to, or greater than, about 0.5 per anhydrous glucose unit.

The polymer may have a DS of the —(C═O)R₇ group ranging from about 0.5 to about 2.5 per anhydrous glucose unit, and R₁ to R₆ may be one selected from an alkyl group, a cycloalkyl group, a heterocycloalkyl group, an aryl group, a heteroaryl group, an alkylaryl group, and an arylalkyl group.

The polymer may have a weight average molecular weight ranging from about 50,000 to about 300,000.

The separation membrane may be a non-porous dense membrane. The separation membrane may be permeable to water and impermeable to a salt. The separation membrane may have a salt rejection rate ranging from about 50% to about 99.9%. The separation membrane forms a contact angle ranging from about 50° C. to about 65° C. with water. The separation membrane has a thickness ranging from about 0.01 μm to about 10 μm.

In a further example embodiment, a composite separation membrane includes the separation membrane; and a supporting layer supporting the separation membrane.

The supporting layer may have a porosity ranging from about 50 to about 80 volume % of the supporting layer.

The separation membrane may be a dense membrane, and the dense membrane may be laminated on at least one side of the supporting layer.

The supporting layer may include at least one selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy-based resin compound, a polyolefin-based compound, a polyphenylenevinylene compound, a polyamide-based compound, a polyacrylonitrile-based compound, a polysulfone-based compound, a cellulose-based compound, polyvinylidene fluoride (PVDF), polytetrafluoroethylene (PTFE), and a polyvinylchloride (PVC) compound.

The composite separation membrane may be configured to be implemented in a reverse or forward osmosis water treatment device.

In another example embodiment, a water treatment device includes the separation membrane. The water treatment may be configured to treat both fresh water and sea water.

The separation membrane has a high water flux and a high salt rejection rate, and also has high mechanical properties and excellent durability due to a high molecular weight.

### BRIEF DESCRIPTION OF THE DRAWINGS

Example embodiments will be more clearly understood from the following detailed description taken in conjunction with the accompanying drawings. FIGS. 1-11 represent non-limiting, example embodiments as described herein.

FIG. 1 is a schematic cross-sectional view showing a composite separation membrane according to one example embodiment.

FIG. 2 is a schematic view showing a process of preparing acetylated methoxy cellulose (AMC) from cellulose.

FIG. 3 is a graph showing water-uptake measured regarding a separation membrane including acetylated methoxy cellulose (AMC16 and AMC18) and a separation membrane including a conventional cellulose derivative (CA and CTA).

FIG. 4 is a DSC (differential scanning calorimetry) graph showing water endothermic peaks measured regarding a separation membrane including acetylated methoxy cellulose (AMC16 and AMC18) and a separation membrane including a conventional cellulose derivative (CA and CTA).

FIG. 5 is a graph showing water contact angles measured regarding a separation membrane including acetylated methoxy cellulose (AMC16 and AMC18) and a separation membrane including a conventional cellulose derivative (CA and CTA).

FIG. 6 is a graph showing a relationship between water/salt solubility selectivity (Kw/Ks) and water partition coefficient (Kw) measured regarding a separation membrane including acetylated methoxy cellulose (AMC16 and AMC18) and a separation membrane including a conventional cellulose derivative (CA and CTA).

FIG. 7 is a graph showing a relationship between water/salt diffusivity selectivity (Dw/Ds) and water diffusivity (Dw) measured regarding a separation membrane including acetylated methoxy cellulose (AMC16 and AMC18) and a separation membrane including a conventional cellulose derivative (CA and CTA).

FIG. 8 is a graph showing a relationship between water/salt permeability selectivity (Pw/Ps) and water permeability (Pw) measured regarding a separation membrane including acetylated methoxy cellulose (AMC16 and AMC18) and another separation membrane including a conventional cellulose derivative (CA and CTA).

FIG. 9 shows cross-section photographs of each thin layer when an acetylated methoxy cellulose (AMC16 and AMC18) thin layer and a conventional cellulose acetate (CA) thin layer are respectively spin-coated on a PAN (polyacrylonitrile) UF film by varying concentration of each polymer.

FIG. 10 is a graph showing a salt (NaCl) rejection rate relative to a water permeation rate measured regarding a separation membrane including an acetylated methoxy cellulose (AMC16 and AMC18) thin layer and a separation membrane including a conventional cellulose derivative (CA and CTA) thin layer.

FIG. 11 is the schematic view of a forward osmosis water treatment device.

### DETAILED DESCRIPTION

This disclosure will be described more fully hereinafter in the following detailed description, in which some but not all example embodiments of this disclosure are described. This disclosure may be embodied in many different forms and is not be construed as limited to the example embodiments set forth herein.

Various example embodiments will now be described more fully with reference to the accompanying drawings in which some example embodiments are shown. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, when a definition is not otherwise provided, the term “substituted” may refer to one substituted with a C1 to C30 alkyl group; a C1 to C10 alkylsilyl group; a C3 to C30 cycloalkyl group; a C6 to C30 aryl group; a C2 to C30 heteroaryl group; a C1 to C10 alkoxy group; a fluoro group, a C1 to C10 trifluoro alkyl group such as a trifluoromethyl group, and the like; or a cyano group. As used herein, when a definition is not otherwise provided, the prefix “hetero” refers to a compound or a substituent including 1 to 3 heteroatoms selected from N, O, S, and P and remaining carbon. As used herein, when a definition is not otherwise provided, the term “combination thereof” refers to more than one substituent combined through a linker or condensed to each other.

As used herein, “*” refers to an attachment point to the same or a different atom or chemical formula.

As used herein, when a definition is not otherwise provided, the term “alkyl” refers to a “saturated alkyl group”, or an “unsaturated alkyl group” without at least one alkenyl or alkynyl. The term “alkenyl” refers to a hydrocarbon group including at least one carbon-carbon double bond, and the term “alkyne group” refers to a hydrocarbon group including at least one carbon-carbon triple bond. The alkyl group may be a branch, linear, or cyclic type. The alkyl group may be a C1 to C30 linear or branch alkyl group, and specifically a C1 to C6 alkyl group, a C7 to C10 alkyl group, or a C11 to C20 alkyl group. For example, a C1 to C4 alkyl group has 1 to 4 carbons in an alkyl chain, and is selected from methyl, ethyl, propyl, iso-propyl, n-butyl, iso-butyl, sec-butyl, and t-butyl. Examples of the alkyl group may include a methyl group, an ethyl group, a propyl group, an isopropyl group, a butyl group, an isobutyl group, a t-butyl group, a pentyl group, a hexyl group, an ethenyl group, a prophenyl group, a butenyl group, a cyclopropyl group, a cyclobutyl group, a cyclopentyl group, a cyclohexyl group, and the like. The term “aromatic group” refers to a substituent including a cyclic structure where all elements have p-orbitals which form conjugation. For example, the aromatic group may include an aryl group and a heteroaryl group.

The term “aryl group” may indicate monocyclic or fused ring-containing polycyclic (i.e., rings sharing adjacent pairs of carbon atoms) groups.

The term “heteroaryl group” may refer to one including 1 to 3 heteroatoms selected from N, O, S, or P in an aryl group, and remaining carbons. When the heteroaryl group is a fused ring, each ring may include 1 to 3 heteroatoms.

The present disclosure relates to a separation membrane and a water treatment device including the separation membrane.

According to one example embodiment, a separation membrane includes a polymer including a structural unit represented by the following Chemical Formula 1.

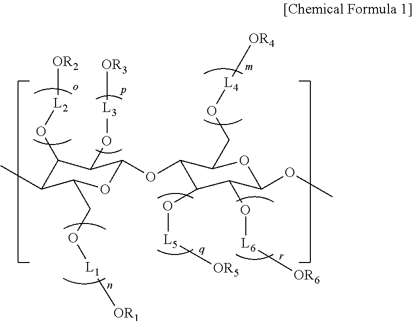

in the above Chemical Formula 1,

R1 to R6 are independently hydrogen, a substituted or unsubstituted C1 to C30 alkyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C6 to C30 heteroaryl group, a substituted or unsubstituted C7 to C30 alkylaryl group, a substituted or unsubstituted C7 to C30 arylalkyl group, or a —(C═O)R₇ group,

wherein, R₇ is a substituted or unsubstituted C1 to C30 alkyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C6 to C30 heteroaryl group, a substituted or unsubstituted C7 to C30 alkylaryl group, or a substituted or unsubstituted C7 to C30 arylalkyl group,

provided that at least one of R₁ to R₃ and at least one of R₄ to R₆ are the same or different, and are a —(C═O)R₇ group,

provided that at least one of R₁ to R₃ and at least one of R₄ to R₆ are the same or different, and are the substituted or unsubstituted C1 to C30 alkyl group, the substituted or unsubstituted C3 to C30 cycloalkyl group, the substituted or unsubstituted C3 to C30 heterocycloalkyl group, the substituted or unsubstituted C6 to C30 aryl group, the substituted or unsubstituted C6 to C30 heteroaryl group, the substituted or unsubstituted C7 to C30 alkylaryl group, or the substituted or unsubstituted C7 to C30 arylalkyl group,

L₁ to L₆ are independently a substituted or unsubstituted C1 to C30 alkylene group, a substituted or unsubstituted C3 to C30 cycloalkylene group, a substituted or unsubstituted C3 to C30 heterocycloalkylene group, a substituted or unsubstituted C6 to C30 arylene group, a substituted or unsubstituted C6 to C30 heteroarylene group, a substituted or unsubstituted C7 to C30 alkylarylene group, or a substituted or unsubstituted C7 to C30 arylalkylene group,

n and m are independently integers ranging from 0 to 150, and

o, p, q, and r are independently integers ranging from 0 to 100.

In the above Chemical Formula 1, the alkyl group or alkylene group may be linear or branched. Specifically, n, m, o, p, q, and r may be independently integers of 2 to 100, and more specifically integers of 2 to 50.

The separation membrane may be a non-porous dense membrane such that the membrane may have a high salt rejection. The dense separation membrane has semi-permeability allowing permeation of water while rejecting (or, alternatively, being impermeable to) a salt. The separation membrane may better permeate water, as it is thinner. For example, the dense separation membrane may be about 0.01 μm to about 10 μm thick.

In general, while the salt permeability is proportional to the water permeability in a membrane, the salt permeability is low and the water permeability is high in the separation membrane. The separation membrane, for example, may have a NaCl rejection rate ranging from about 50% to about 99.9%. In the above Chemical Formula 1, a —(C═O)R₇ substituent forms an ester group, which applies solvability in an organic solvent to the separation membrane to be prepared. The polymer includes at least greater than, or equal to, a set amount of the hydrophobic ester group, and may maintain hydrophilicity of a cellulose polymer main chain itself and insolubility in water. Accordingly, because the polymer includes a —(C═O)R₇ substituent in the above Chemical Formula 1 (hereinafter, an “ester group-forming substituent”), a membrane including the polymer may not be dissolved in water, and may be dissolved in an organic solvent (e.g., acetone, acetic acid, methanol, isopropanol, 1-methoxy-2-propanol, trifluoroacetic acid (TFA), tetrahydrofuran (THF), pyridine, methylene chloride, dimethyl formamide (DMF), dimethyl acetamide (DMAC), N-methyl-2-pyrrolidone (NMP), terpineol, 2-butoxyethylacetate, 2(2-butoxyethoxy)ethylacetate, and/or the like). The polymer may be used to manufacture a membrane, for example, in a method of solvent casting, wet spinning, dry spinning, and the like, and also has a melting point and thus may be used to manufacture a membrane in a method of melt processing, melt spinning, and the like.

The polymer has a DS (degree of substitution) of a —(C═O)R₇ substituent represented in the above Chemical Formula 1 of greater than, or equal to, about 0.5 per anhydrous glucose unit, and specifically, in a range of about 0.5 to about 2.5. In more particular, the —(C═O)R₇ substituent represented in the above Chemical Formula 1 may have a DS ranging from about 0.8 to about 2 per anhydrous glucose unit. The —(C═O)R₇ substituent represented in the above Chemical Formula 1 may have a DS ranging from about 1 to about 3 per anhydrous glucose unit. When the polymer has a DS of the —(C═O)R₇ substituent represented in Chemical Formula 1 (ester group-forming substituent) within the disclosed range, a membrane including the polymer may maintain hydrophilicity of a cellulose polymer main chain, and insolubility in water. When the DS is smaller than 0.5, the polymer becomes water-soluble and may not be used to manufacture a membrane, unless a substituent other than the —(C═O)R₇ substituent (e.g., an “ether-forming substituent and the like” described hereinafter) is used to maintain insolvability in water. The polymer forms an ether group when R₁ to R₆ in the above Chemical Formula 1 have a substituent such as an alkyl group, a cycloalkyl group, a heterocycloalkyl group, an aryl group, a heteroaryl group, an alkylaryl group, an arylalkyl group, or the like. When the R₁ to R₆ in the above Chemical Formula 1 are an alkyl group, a cycloalkyl group, a heterocycloalkyl group, an aryl group, a heteroaryl group, an alkylaryl group, or an arylalkyl group (hereinafter, an ether-forming substituent), the solubility of the polymer may be adjusted for a particular solvent, as well as the hydrophilicity of the polymer, by controlling kinds of the R₁ to R₆ substituents in the above Chemical Formula 1 and a degree of substitution.

The polymer may have a DS ranging from about 0.5 to about 2.5 per anhydrous glucose unit when the R₁ to R₆ are an alkyl group, a cycloalkyl group, a heterocycloalkyl group, an aryl group, a heteroaryl group, an alkylaryl group, or an arylalkyl group. The polymer includes the ether-forming substituent along with the ester-forming substituent and thus may increase water permeability more than a polymer including only the ester-forming substituent. The reason is that the ether-forming substituent is more desirable than the ester-forming substituents in terms of free volume. Accordingly, the DS of the ether-forming substituent and the DS of the ester-forming substituent may each be adjusted to accomplish desired characteristics of a separation membrane including the polymer. In addition, the polymer includes the ether-forming substituent and may increase chemical stability in a wide range of pHs and oxidation conditions. The degree of substitution (DS) denotes an average number of substituted hydroxyl groups per anhydrous glucose unit. Because three hydroxyl groups, at most, per anhydrous glucose unit are substituted, the theoretical maximum DS is three when a mono-functional substituent is substituted.

The polymer is prepared to have a high molecular weight in a manufacturing method described later, and thus accomplishes high strength. For example, the polymer has a weight average molecular weight ranging from about 20,000 to about 800,000. Specifically, the polymer may have a weight average molecular weight ranging from about 50,000 to about 300,000 considering properties of a membrane. When the polymer has a molecular weight within the range, the polymer may have appropriate strength for a membrane. When the weight average molecular weight is greater than or equal to about 500,000, the polymer tends to have less solubility. Accordingly, a weight average molecular weight of the polymer may be adjusted depending on a thickness of an active layer of a separation membrane by a person of ordinary skill in the art.

Hereinafter, a method of manufacturing the polymer is illustrated.

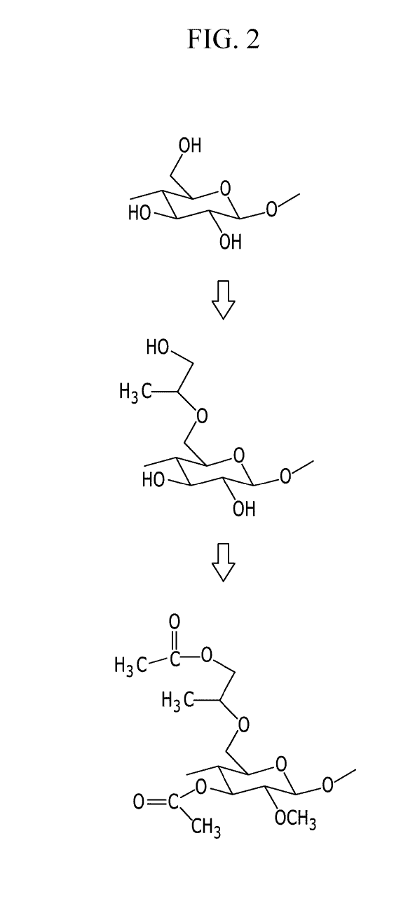

FIG. 2 is a schematic view showing a process of preparing acetylated methoxy cellulose (AMC) from cellulose.

Referring to FIG. 2, the polymer is prepared by etherifying a cellulose compound to obtain a cellulose ether compound having at least one hydroxyl group, and esterifying the cellulose ether compound to obtain esterified cellulose ether. Specifically, the method of manufacturing the polymer according to one example embodiment includes substitution of an alkyl group, a cycloalkyl group, a heterocycloalkyl group, an aryl group, a heteroaryl group, an alkylaryl group, or an arylalkyl group (hereinafter, referred to as a substituent), or an alkyl group including at least one hydroxy group, a cycloalkyl group including at least one hydroxy group, a heterocycloalkyl group including at least one hydroxy group, an aryl group including at least one hydroxy group, a heteroaryl group including at least one hydroxy group, an alkylaryl group including at least one hydroxy group, or an arylalkyl group including at least one hydroxy group (hereinafter, referred to as a substituent including at least one hydroxy group), for hydrogen atoms of at least a part of the hydroxy groups in cellulose. Herein, the alkyl group, or an alkyl group in the substituent, may be either linear or branched as mentioned above. The hydrogen atoms of the substituent including at least one hydroxy group may be additionally substituted with the above-described substituent or a substituent including at least one hydroxyl group. In this way, when a substituent or a substituent including at least one hydroxyl group is substituted for hydrogen atoms of the additionally-substituted hydroxy group, the substituents are duplicatively linked and form -(0-L₁)ₙ-, -(0-L₂)ₒ-, -(0-L₃)ₚ-, -(0-L₄)ₘ-, -(0-L₅)_{q}- and -(0-L₆)ᵣ- repeatedly linked in the Chemical Formula 1.

A cellulose compound primarily undergoes an etherification reaction where a hydrogen bond is broken and it is converted into a non-crystalline structure. The synthesized cellulose ether has a non-crystalline structure, and the hydroxyl group included therein has excellent reactivity. Next, a —(C═O)R₇ group is substituted for hydrogen atoms of the hydroxy group having excellent reactivity (this substitution reaction is called “esterification”, and the R₇ is the same as defined above), obtaining esterified cellulose ether.

According to the manufacturing method, cellulose is sequentially etherified and esterified, preparing an esterified cellulose derivative but rarely decreasing its molecular weight. In other words, because the manufacturing method does not need to break the crystalline structure of cellulose during esterification, and does not use a polar catalyst (e.g., an inorganic acid) to break a crystalline structure of cellulose, a main chain therein does not break from use of a polar catalyst, and esterified cellulose ether may have a high molecular weight. When the esterified cellulose ether with a high molecular weight is used to fabricate a separation membrane, the separation membrane may have high strength and excellent durability and hydrophilicity.

The separation membrane including the polymer may be examined regarding hydrophilicity by dripping water (water droplet) on the surface and measuring its contact angle. For example, the RCO— group may be measured, and the degree of substitution of the RCO— group may be adjusted by titration. For example, the separation membrane including the polymer may have a contact angle ranging from about 50° to about 65° with water. The separation membrane including the polymer has improved hydrophilicity, and thus may decrease water permeation resistance.

According to another example embodiment, the separation membrane includes a supporting layer other than a dense membrane including the polymer, which may be formed into a composite membrane.

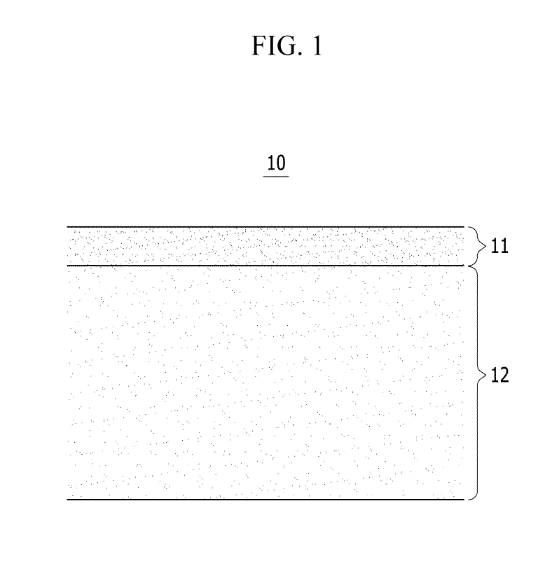

FIG. 1 is a schematic cross-sectional view showing a composite separation membrane according to one example embodiment.

Referring to FIG. 1, a composite separation membrane 10 includes a dense membrane 11 including the aforementioned polymer and a supporting layer 12 stacked thereunder.

The dense membrane 11 including the polymer may be formed on one side, or both sides, of the supporting layer 12. The supporting layer 12 may be porous, and apply mechanical strength to the separation membrane 10. For example, the supporting layer 12 may include a pore with a finger-like structure and the like, and have a porosity ranging from about 50 to about 80 volume %. The porosity denotes the relative volume of pores out of the entire layer volume and may be measured by performing a method known in the art using commercially-available equipment.

The supporting layer 12 may have a thickness less than about 200 μm, specifically in a range of about 10 μm to about 200 μm, for example, about 25 μm to about 100 μm.

The supporting layer 12 may be formed of any polymer used as a layer material without any limit, and for example, may include at least one selected from the group consisting of a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy-based resin compound, a polyolefin-based compound, a polyphenylenevinylene compound, a polyamide-based compound, a polyacrylonitrile-based compound, a polysulfone-based compound, a cellulose-based compound, polyvinylidene fluoride (PVDF), polytetrafluoroethylene (PTFE), and a polyvinyl chloride (PVC) compound.

The membrane 11 including the polymer is a dense polymer layer, and thus has a higher rejection rate against a salt (a subject material to be separated) than the supporting layer 12. As described above, because the supporting layer 12 is a porous layer having pores of a finger-like structure and the like, while the polymer membrane 11 is a non-porous dense layer, the polymer membrane 11 has a higher rejection rate against a subject material to be separated (e.g., a salt) than the supporting layer 12. The polymer membrane 11 is used to fabricate a separation membrane by performing a well-known method, and the present disclosure is not limited thereto. For example, the method may include solvent casting, spin coating, wet spinning, dry spinning, and the like, and also a melt process (e.g., extrusion, melt spinning, and the like). Specifically, as for the solvent casting, a separation membrane may be fabricated by dissolving a polymer including a structural unit represented by the above Chemical Formula 1, casting the solution on the surface of a supporting layer, and drying it. The solution may include the polymer in a concentration ranging from about 0.1 wt % to about 50 wt %.

According to the one example embodiment, a separation membrane may be fabricated as a reverse osmosis or forward osmosis membrane depending on its use. The reverse osmosis or forward osmosis separation membrane may be fabricated by performing a well-known manufacturing method, and the present disclosure is not limited thereto. For example, the separation membrane 10 may be fabricated by coating a solution including the polymer on a supporting layer 12 using a well-known method to form a polymer dense membrane 11. The separation membrane may be applied to, for example, salinity difference generation using osmotic pressure as well as water treatment such as water purification, wastewater treatment and recycling, desalination of sea water, and the like.

According to another example embodiment, a water treatment device including the separation membrane is provided. The water treatment device filters a salt (e.g., NaCl and the like) or microorganisms, a floating material, and the like, but allows only water to pass through the separation membrane. Thus, the water treatment device is configured to treat both sea water and fresh water. In addition, the water treatment device may be used to concentrate a biological active material to manufacture a medicine, or to prepare ultrapure water used to manufacture a semiconductor, but the present disclosure is not limited thereto. The water treatment device may be a forward, or reverse, osmosis water treatment device.

The forward osmosis water treatment device may include a first housing including a member receiving a feeding solution including a subject material to be separated, another member receiving an osmosis draw solution having a higher osmosis pressure than the feeding solution, and a separation membrane disposed between the two members, a second housing supplying the first housing with the osmosis draw solution and retrieving the osmosis draw solution from the first housing and storing the osmosis draw solution, and a recovering system separating and retrieving a solute from the osmosis draw solution.

The forward osmosis water treatment device may further include a member discharging treated water after separating a draw solute from the osmosis draw solution including water passed through the separation membrane from the feeding solution due to osmotic pressure using the recovering system. The forward osmosis water treatment device works as follows. Water in a feeding solution for treatment is moved toward an osmosis draw solution having a higher concentration using osmotic pressure, and the osmosis draw solution including the water is moved to a recovering system to separate a solute therefrom and to discharge the rest as treated water. In addition, the separated draw solute is reused to contact a new feeding solution for treatment.

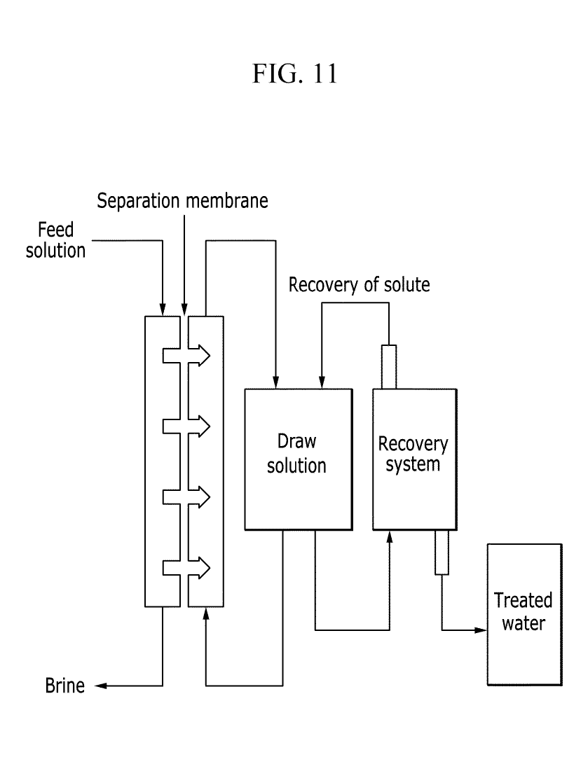

FIG. 11 is a schematic view of a forward osmosis water treatment device operated according to this mechanism.

The forward osmosis process uses an osmosis draw solution having a higher concentration than a feeding solution, moves water molecules from the feeding solution to the osmosis draw solution, separates and reuses a draw solute from the feeding solution, and generates fresh water. The feeding solution may, for example, include sea water, brackish water, wastewater, tap water treated for drinking water, and the like. Accordingly, the forward osmosis water treatment device may be used for, as examples, water purification, wastewater treatment and reuse, desalination of sea water, and the like.

As described above, because a separation membrane according to example embodiments maintains hydrophilicity of a cellulose polymer main chain by esterifying cellulose and is insolvable in water, and in addition has a high molecular weight, it may exhibit high mechanical strength, high water permeation, and high salt rejection. Thus, the separation membrane may be widely used for a water treatment device using a forward or reverse osmosis process.

Hereinafter, example embodiments are specifically illustrated. However, the following example embodiments are specifically described or explained, but do not limit the scope of the disclosure.

### EXAMPLES

### Synthesis Example 1

### Synthesis of Acetylated Methyl Cellulose (AMC)

Hydroxy propyl methyl cellulose (HAC) (Mecellulose®, Samsung Fine Chemicals, Ulsan, Korea), sodium acetate (CH₃COONa), and acetic acid anhydride ((CH₃CO)₂O) are mixed, and the mixture is vigorously agitated at 85° C. for 8 hours. When the reaction is complete, the reactant is precipitated in water and filtrated. Finally, the filtrated product is cleaned several times with deionized water and dried in a vacuum oven. The AMC is measured regarding degree of acetylation (DA) using ASTM D871-96. Because cellulose of D-glucose has three hydroxyl groups per repeating unit, a possible maximum degree of substitution (DS) is 3.0. The hydroxy propyl methyl cellulose (HAC) (Mecellulose®) used as a raw material in the synthesis has a degree of substitution (DS) for a methoxy group of 1.84. The acetyl group has a maximum wt % ranging from about 18 wt % to about 20 wt % of the entire polymer. Accordingly, two kinds of AMC's (e.g., AMC16 including 16.8% of acetyl and AMC18 including 18.9% of acetyl) are prepared. The AMC's are measured regarding weight average molecular weight (Mw) through gel permeation chromatography (Waters GPC instrument, Waters Corp., Milford, Mass.).

### Synthesis Example 2

### Separation Membrane

### 1) Fabrication of AMC Dense Membrane

A thick dense AMC membrane is fabricated in a thermal evaporation method in order to measure permeability, diffusivity, and a solubility coefficient of water and a salt (e.g., NaCl). The two AMC powders (AMC16 and AMC18) according to Synthesis Example 1 are dissolved in DMAc (N,N-dimethyl acetamide) (>99.9%, Sigma-Aldrich (St. Louis, Mo.)). The solution is agitated for a night and filtered in a vacuum filtration method to remove impurities therein. The filtered solution is completely degassed in an ultrasonic wave bath. The AMC solution with viscosity is cast on a dean glass plate and put in a 120° C. vacuum oven to evaporate a solvent therein. The obtained AMC dense membrane is cleaned with deionized water for 7 to 8 hours to remove a remaining solvent and maintained in a 120° C. vacuum oven again before measuring water permeability and kinetic desorption. In order to measure the kinetic desorption, a relatively thick AMC membrane (about 200 μm) is fabricated, while in order to measure hydraulic water permeability, a relatively thin AMC membrane (about 20 to 30 μm) is fabricated. These dense membranes are used to measure liquid water absorption at 25° C.

### 2) AMC Thin-Film-Composite Membranes

A thin AMC dense membrane is coated using a spin coater on a polyacrylonitrile (PAN) UF membrane (PAN350, water flux=1000 L/m²·h·bar, MWCO: 20 kDa, Sepro Membranes, Inc., Oceanside, Calif.) as a supporting layer in order to evaluate a salt rejection rate of an AMC separation membrane using a reverse osmosis method. The coating solution includes acetone as a solvent due to high volatility and insolubility for the PAN micropore membrane. Science AMC has a higher molecular weight than commercially-available CA (cellulose acetate: CA-398-10, 39.8% of an acetyl group, Eastman Kodak (Kinsport, Tenn.)), an AMC solution having a lower polymer concentration (about 1 wt %) in the acetone solvent is used to fabricate a thin film. After the AMC solution with viscosity is dripped in the center of the PAN UF membrane surface, a less than 1 μm-thick thin AMC dense membrane is formed in a spin-casting method. The spin-coating speed is fixed to be 2000 rpm for 30 seconds. On the other hand, a PAN composite membrane coated with the CA thin film is fabricated in the same method for comparison with the AMC dense membrane. The acetone includes CA in a concentration ranging from about 1 wt % to about 5 wt %. All the membranes are completely dried in a 50° C. vacuum oven before use.

### Experimental Example 1

### Membrane Inherent Characteristic Evaluation

The AMC dense membrane is measured regarding water permeability (P_{W}^{H}) through a high-pressure-dead-end filtration experiment. The AMC dense membrane according to Synthesis Example 2 is put in a stirred cell (HP4720, Sterlitech, Kent, Wash.), and 250 mL of deionized water is flowed therein. Then, a nitrogen cylinder is used to apply a pressure at 55 bar (800 psi) to the AMC dense membrane. The amount of permeated water depending on time is measured using an electron scale connected to a personal computer. Because the water transfer in a dense polymer membrane is explained through a solution-diffusion mechanism, diffusion water permeability (P_{W}^{D}) is calculated according to the following Equation 1.

$${P}_{W}^{D} = {P}_{W}^{H} \frac{RT}{{V}_{W}} \qquad [ Equation 1 ]$$

In the above Equation 1, P_{W}^{D} is diffusivity, R is an ideal gas constant, T is a measurement temperature, and V_{W} is a mole volume of water. In addition, a partition coefficient of the water is obtained through a water uptake experiment. The dried membrane specimen is dipped in deionized water, and a water droplet on the surface is removed and regularly measured regarding mass until the specimens reaches an equilibrium state. The water uptake (ω_{W}) and water solubility (K_{W}) of the specimens are calculated according to the following Equations 2 and 3.

$$\begin{matrix}{ω}_{W} = \frac{{m}_{h} - {m}_{d}}{{m}_{d}} & [ Equation 2 ] \\ {K}_{W} = \frac{( {m}_{h} - {m}_{d} ) / {ρ}_{W}}{( {m}_{h} - {m}_{d} ) / {ρ}_{W} + {m}_{d} / {ρ}_{d}} & [ Equation 3 ]\end{matrix}$$

In the above Equations 2 and 3, ρ_{w} and ρ_{d} are respectively water density and polymer density when the specimen is dried, and mₕ and m_{d} are respective masses of the hydrated specimen and the dried specimen. Finally, the water diffusivity coefficient is calculated from the water permeability, and a solubility coefficient is found according the following Equation 4.

$${P}_{W}^{D} = {K}_{W} \cdot {D}_{W} = {P}_{W}^{H} \cdot \frac{RT}{\overline{{V}_{W}}} [ {( 1 - {K}_{W} )}^{2} ( 1 - 2 χ {K}_{W} ) ] \qquad [ Equation 4 ]$$

In Equation 4, D_{W} is an average effective water diffusion coefficient all over the membrane, R is an ideal gas constant, T is an absolute temperature during the measurement, and c is a Flory-Huggins interaction parameter. In a Flory-Huggins theory, chemical potential a_{W} of water in a hydrated polymer is related to a concentration of the water in the polymer as shown in the following Equation 5.

ln a_{W}=ln K_{W}(1−K_{W})+χ(1−K_{W})² [Equation 5]

In Equation 5, a_{W} is a volume fraction of the water in an equilibrium state, and χ is an interaction parameter between water/polymer. Then, diffusivity, solubility, and a permeability coefficient of NaCl are measured by performing a kinetic desorption experiment. The about 200 μm-thick AMC dense membrane specimen (3.14 cm² of area) according to the item 1) of Synthesis Example 2 is dipped in 60 ml of a 1 M NaCl solution for greater than or equal to 7 days and completely saturated with the NaCl salt. Next, excessive liquid drops on the surface of the specimen are wiped off with a tissue and removed, and the specimen is immediately placed in a desorption cell filled with 60 ml of deionized water and having a thermostat.

The desorption cell is recorded regarding an electrical conductivity increase depending on time. The NaCl solubility coefficient, diffusivity, and permeation coefficient are calculated according to the following Equations 6 and 7.

$$\begin{matrix}{D}_{s} = \frac{π {l}^{2}}{16} {( \frac{d ( {M}_{t} / {M}_{inf} )}{d {t}^{0.5}} )}^{2} & [ Equation 6 ] \\ {K}_{s} = \frac{{M}_{inf} / {V}_{m}}{{M}_{d} / {V}_{s}} & [ Equation 7 ]\end{matrix}$$

In Equations 6 and 7, Dₛ is diffusivity of a salt, Mₜ is a salt concentration of the desorption cell at a temperature t, M_{inf} is an equilibrium salt concentration of the desorption cell, M_{d} is a salt concentration of a donor solution (1M), Vₘ and Vₛ are respectively volumes of a wet membrane and the donor solution, and I is an average thickness of the membrane.

In order to evaluate surface wettability of the membrane, a contact angle on the surface of the AMC dense membrane is measured using optical equipment (Phoenix 300, SEO, Suwon, Korea). The dried membrane specimen is placed on a flat glass substrate, and the same amount of water as in a syringe is dripped on the surface. After dripping the water, an image is immediately recorded by fixing a tip 0.5 cm apart from the substrate to prevent the water from spreading away. Five measurements from five different places are averaged. In order to evaluate water state in a cellulose polymer, the water in the polymer is examined regarding melting point change by using DSC equipment (DSC Q20, TA Instruments, New Castle, Del.). About 20 mg of each polymer membrane specimen is put in an aluminum pan and cooled to 70° C. for 10 minutes. Heat flow change is recorded from −70° C. to 30° C. The temperature is increased at a speed of 5° C./min.

### Experimental Example 2

### Salt Rejection Rate of Separation Membrane Using Reverse Osmosis Process

In order to evaluate water permeability and salt removal characteristics, a composite membrane coated with the AMC thin layer according to the item 2) of Synthesis Example 2 and a composite membrane coated with a conventional CA thin layer are used. The coating membranes formed from various coating solution concentrations have a thickness ranging from less than 0.1 μm to several micrometers. The thin coating membranes are evaluated using high pressure quantitative batch filtering equipment (HP4750, Sterlitech, Kent, Wash.). In order to secure stability, all the membranes are pre-pressed at 69 bar with deionized water for 2 hours. The membranes are continually measured regarding water flux change using an electronic scale connected to a personal computer. When the membranes are stabilized, a reverse osmosis experiment is performed at 25° C. and 55 bar (800 psi). Herein, a feeding solution including NaCl in a concentration of 2000 ppm is used. A conductivity measuring device (Inolab® Cond 730, WTW, Weilheim, Germany) is used to measure concentration of permeated NaCl. A NaCl rejection rate is calculated according to the following Equation 8.

R=(C_{f}−Cₚ)/C_{f}×100 [Equation 8]

In Equation 8, C_{f} denotes concentration of the feeding solution, and for example, sea water has a NaCl concentration ranging from about 35,000 ppm, Cₚ denotes a concentration after the purification, and R denotes a salt rejection rate (%).

### Results

### 1) Physical Characteristic of AMC Dense Membrane

The AMC dense membrane according to the item 1) of Synthesis Example 2 and a commercially-available cellulose ester polymer (CA (cellulose acetate) and CTA (cellulose triacetate)) for comparison are provided regarding chemical composition, molecular weight, melting point, and the like in the following Table 1.

TABLE 1

| | | | | | CPC | |
|---|---|---|---|---|---|---|
| | | | | | (Critical Polymer | |
| | Molecular | Substitution Amount | | | Concentration) | Melting |
| Polymer | Weight (kDa) | —OH (%) | —OAc (%) | —OMe (%) | (%) | Point (° C.) |
| AMC | 220-280 | 0 | 18-20 | 26.2 | 10 | 190-220 |
| CA | 40 | 3.5 | 39.8 | 0 | 19 | 230-250 |
| CTA | 50 | 0.82 | 43.6 | 0 | 12 | 269-300 |

The CA and CTA are well-known and established as ultrafiltration (UF) and reverse osmosis (RO) membrane materials. In general, physical and chemical characteristics of a cellulose material depend on the composition of an ester group. A hydroxyl group in a cellulose structure may be transformed into another functional group, such as an organic and inorganic ester and alkyl or a hydroxy alkyl ether. The AMC prepared in the item 1) of Synthesis Example 2 has different amounts and degrees of substitution of hydroxy, acetyl, and methoxy. The completely substituted AMC (AMC18) does not include a hydroxyl group. In general, CA is more hydrophilic than the other cellulose derivatives used in the experiment due to the hydroxyl group. The CA has a decreased hydrogen bond when a methyl group is substituted for an acetate and/or a hydroxy group as a donor. Resultantly, each dense membrane includes various amounts of water.

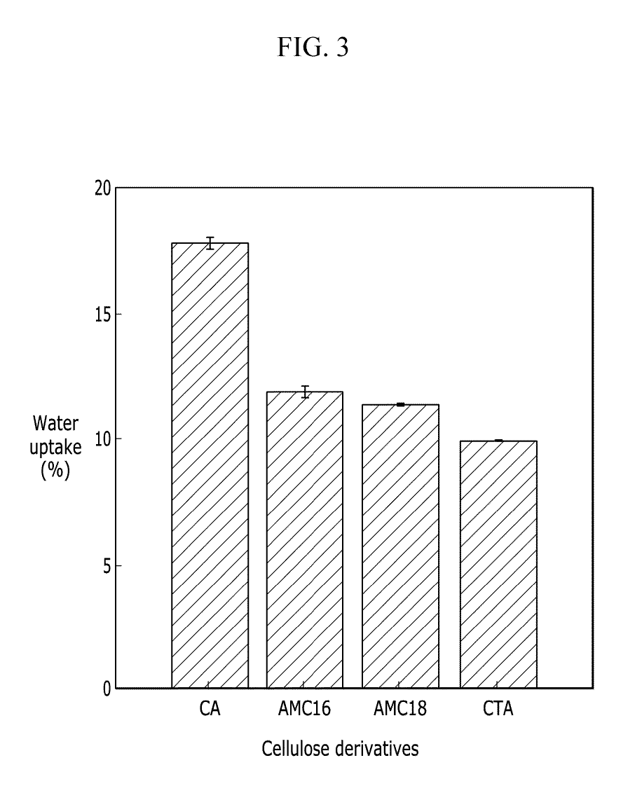

FIG. 3 is a graph showing water-uptake measured regarding a separation membrane including acetylated methoxy cellulose (AMC16 and AMC18) and a separation membrane including a conventional cellulose derivative (CA and CTA).

FIG. 3 is a graph showing water uptake measured at 25° C. regarding the AMC (AMC16 and AMC18) dense membranes according to item 1) of Synthesis Example 2 and the CA (cellulose acetate) and CTA (cellulose triacetate) dense membranes provided in Table 1 for comparison as described in Experimental Example 1. The highly substituted CTA dense membrane has the lowest water uptake among the polymers and relatively lower water permeability. When an acetyl group is substituted for a hydroxyl group in a cellulose polymer, a CTA polymer may be better dissolved in an organic solvent but resultantly loses hydrophilicity. The CA dense membrane has the highest water uptake. The AMC membrane has a water uptake ranging from about 11 wt % to about 12 wt %. The AMC16 includes an unreacted hydroxyl group and accordingly has a little higher water uptake than the AMC18 including no hydroxyl group.

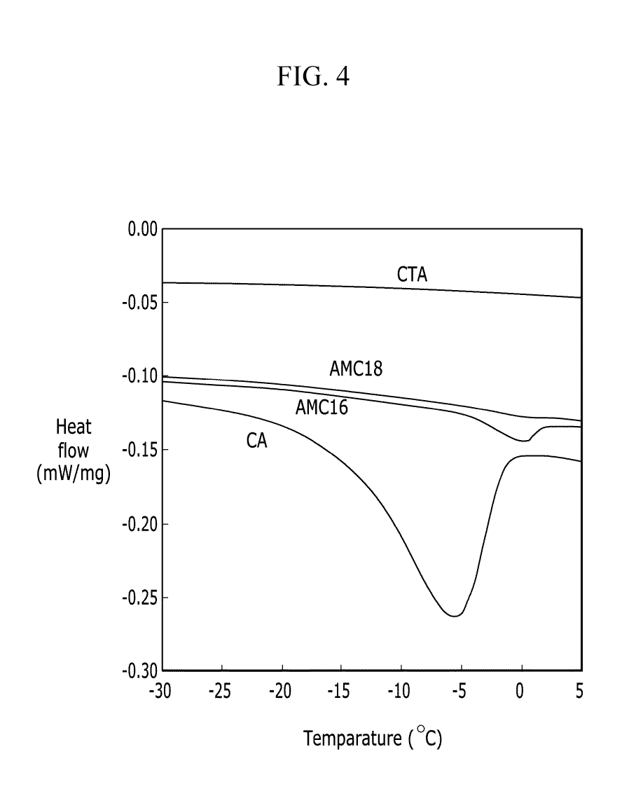

FIG. 4 is a DSC (differential scanning calorimetry) graph showing water endothermic peaks measured regarding a separation membrane including acetylated methoxy cellulose (AMC16 and AMC18) and a separation membrane including a conventional cellulose derivative (CA and CTA).

FIG. 4 shows a DSC measurement results showing a water endothermic peak inside a swollen polymer at around 0° C. The CA membrane has an endothermic peak at about −5° C., which shows that the polymer has a strong bond with a water molecule due to the hydroxyl group. The CTA membrane has no endothermic peak. The reason is that the swollen CTA membrane includes so little water that it is difficult to detect. On the other hand, the AMC membrane has a small endothermic peak at 0° C. The DSC result tends to be the same as the water uptake.

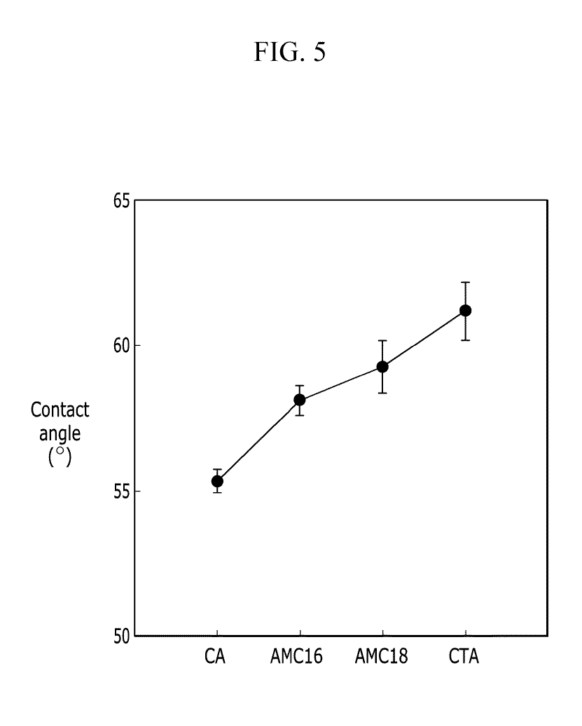

FIG. 5 is a graph showing water contact angles measured regarding a separation membrane including acetylated methoxy cellulose (AMC16 and AMC18) and a separation membrane including a conventional cellulose derivative (CA and CTA).

FIG. 5 shows surface wettability of the CA, AMC, and CTA dense membranes. In general, when cellulose is more acetylated, the cellulose has a larger surface contact angle. The reason is that the cellulose loses a hydrophilic hydroxyl group in its chain. Accordingly, the CA including the high amount of a hydroxyl group has the lowest contact angle and thus has the highest wettability. The AMC includes a hydroxyl group in a lower amount than the CTA. However, the AMC has wettability between those of the CA and CTA, which is the same as the water uptake result.

The water and salt permeability of the CA membrane is very sensitive to degree of acetylation (DA) of the CA. On the other hand, pure cellulose including a free hydroxyl group in a large amount has high crystallinity (about 70%) and thus is not dissolved in water. However, when the hydroxyl group is transformed into an acetyl group, regularity in a polymer chain is deteriorated, and thus decreases crystallinity of the CA and increases a hydrogen bond among the polymer chains. In addition, the CA membrane variously absorbs water depending on the amount of acetate. For example, when the CA includes more acetate, it becomes water-soluble. However, when the acetate is more substituted, the CA becomes hydrophobic again. When the CA includes about 19 wt % of an acetyl group, the CA becomes solvable in an organic solvent. In general, the CA absorbs less water when more acetyl is included within a range of 25 to 45 wt %. Resultantly, water and salt permeability (i.e., salt permeability) of the CA membrane largely depends on the amount of acetate.

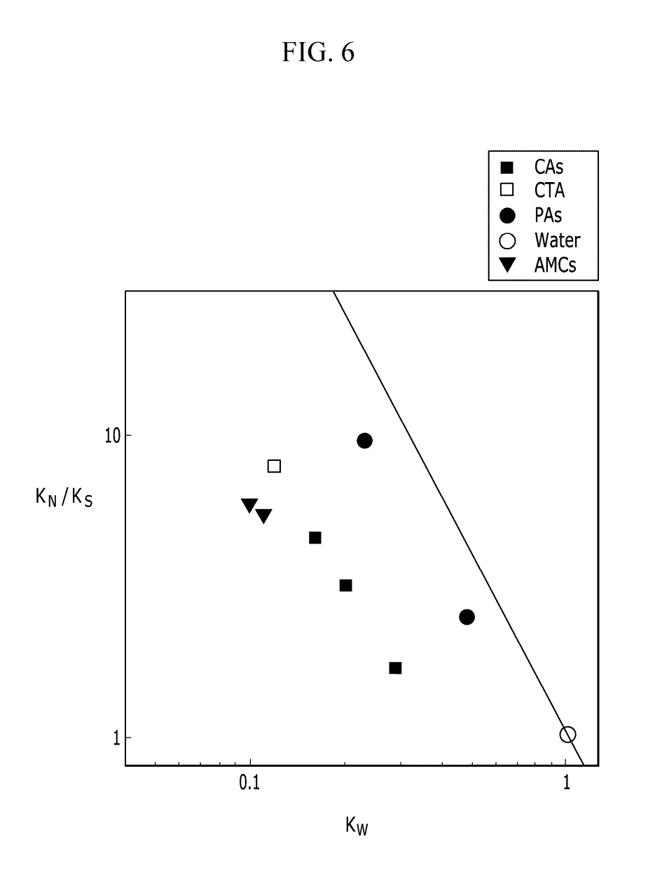

FIG. 6 is a graph showing a relationship between water/salt solubility selectivity (Kw/Ks) and water partition coefficient (Kw) measured regarding a separation membrane including acetylated methoxy cellulose (AMC16 and AMC18) and a separation membrane including a conventional cellulose derivative (CA and CTA).

In general, when a polymer absorbs less water, the polymer is predicted to have high water/salt solubility selectivity. The water/salt solubility selectivity of the CA membrane is deeply related to a chemical structure, that is, an ester group. Based on the water uptake result, the CTA and AMC has a much lower water desorption amount than the CA including a hydroxyl group. Because NaCl has more solubility depending on the water amount, the CA including more hydroxyl groups in the place of an ester group has relatively lower solubility selectivity but higher water solubility. Particularly, the AMC membrane has a lower water partition coefficient than the CA and other polymers due to a hydrophobic methoxy group and a dense structure.

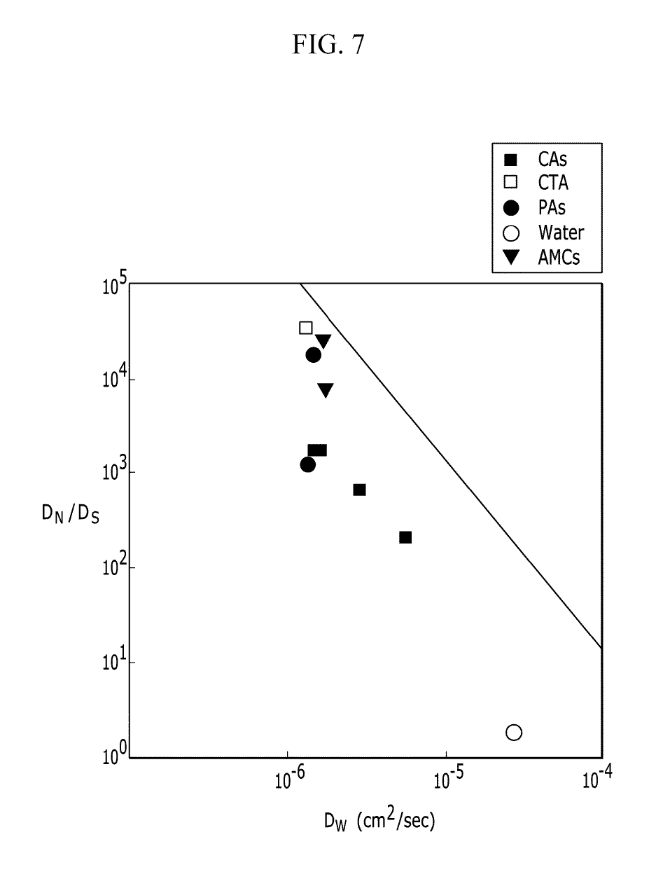

FIG. 7 is a graph showing a relationship between water/salt diffusivity selectivity (Dw/Ds) and water diffusivity (Dw) measured regarding a separation membrane including acetylated methoxy cellulose (AMC16 and AMC18) and a separation membrane including a conventional cellulose derivative (CA and CTA).

Referring to FIG. 7, the CA has a water/salt diffusivity difference largely depending on a degree of substitution. The CTA shows the highest water/salt diffusion selectivity among the CA and the other polymers. The salt diffusion is very sensitive to the amount of an acetyl group and a hydroxyl group of the CA. The AMC and CA membranes have no large water diffusivity change considering the amount of a methoxy group, while a salt diffusivity difference depends on the amount of an acetyl group.

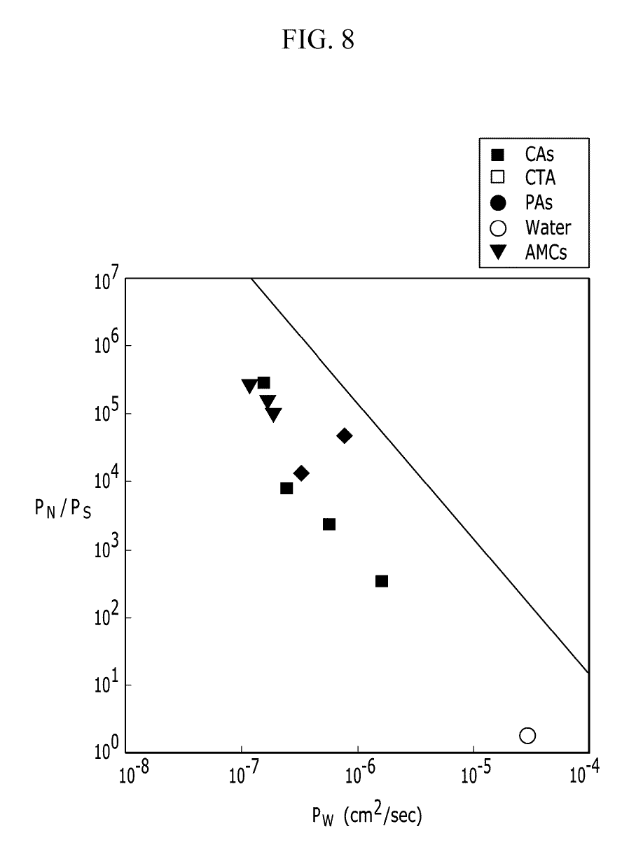

FIG. 8 is a graph showing a relationship between water/salt permeability selectivity (Pw/Ps) and water permeability (Pw) measured regarding a separation membrane including acetylated methoxy cellulose (AMC16 and AMC18) and another separation membrane including a conventional cellulose derivative (CA and CTA).

FIG. 8 shows a correlated relationship between water permeability (Pw) and water/salt permeability selectivity (Pw/Ps), and the permeability is a product of solubility and diffusivity in a dissolution-diffusion mechanism. The highly acetylated CA and AMC have relatively lower water permeability (about 10⁻⁷ cm²/sec) but high water/salt permeability selectivity than the lowly-acetylated CA. The AMC18 has no hydrophilic group such as a hydroxyl group in a polymer chain, but has higher permeability than the CTA. Furthermore, the AMC18 has remarkably improved water/salt permeability selectivity compared with the CA (DA=39.8%) that is damaged on water permeability. Accordingly, the AMC has high water/salt selectivity and thus rejects a salt well. Because the AMC has as good solubility in an organic solvent (acetone, methyl chloride, DMF, DMAc, NMP, and the like) as the CA or better than the CA, the AMC may be improved regarding actual water permeability up to a commercially available separation membrane by using a phase transition or a thin film coating technology in order to be used as a water treatment separation membrane.

2) Performance of Reverse Osmosis Composite Membrane Coated with AMC Thin Film

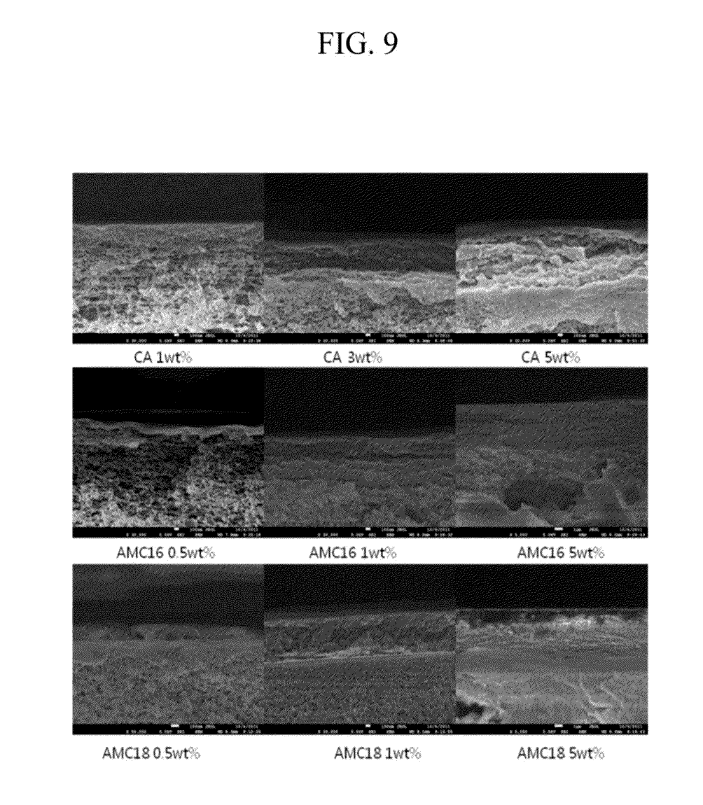

FIG. 9 shows cross-section photographs of each thin layer when an acetylated methoxy cellulose (AMC16 and AMC18) thin layer and a conventional cellulose acetate (CA) thin layer are respectively spin-coated on a PAN (polyacrylonitrile) UF film by varying concentration of each polymer.

A composite membrane coated with a commercially available CA thin film and another composite membrane coated with the AMC thin film according to Synthesis Example 2 includes variously spin-coated thin film layer shapes due to different molecular weight and solution viscosity of the polymers, as shown in FIG. 9.

As shown in Table 1, the AMC according to Synthesis Example 1 has a much higher molecular weight than a commercially available CA. Providing 5 wt % of the same solution concentration, the AMC is coated to have a thickness (>5 μm) and to be thicker than the thickness (about 1 μm) of the CA due to the high molecular weight of the AMC. Because salt rejection and water permeability of the membrane largely depend on thickness of a surface layer, the same thin film is hard to fabricate using different polymers, and accordingly, various CA and AMC thin film composite membranes fabricated from different solution concentrations are tested regarding the reverse osmosis process.

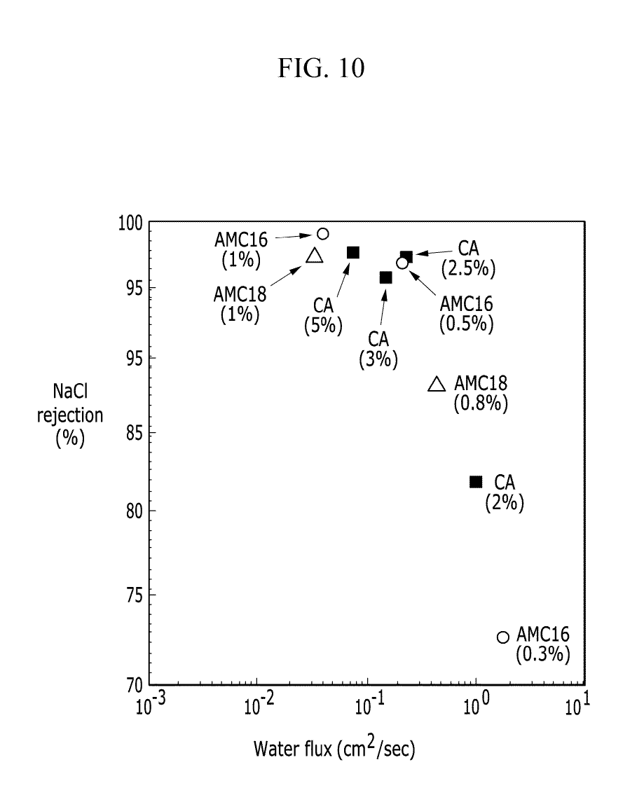

FIG. 10 is a graph showing a salt (NaCl) rejection rate relative to a water permeation rate measured regarding a separation membrane including an acetylated methoxy cellulose (AMC16 and AMC18) thin layer and a separation membrane including a conventional cellulose derivative (CA and CTA) thin layer.

FIG. 10 shows reverse osmosis performance of the AMC membrane compared with the CA membrane. The thin film coated composite membrane has water permeability measured from filtration of deionized water at 800 psi (about 54.4 bar). The CA and AMC coated membranes have water permeability that increases from 0.04 L/m²·h·bar to 2 L/m²·h·bar as the coating layers become thinner due to a thickness difference of the coating layers. The AMC has similar water permeability and salt rejection to the CA. In addition, the CA and AMC coated membranes have various NaCl (2000 ppm) rejection rates ranging from 72% to 99%.

Resultantly, the AMC separation membrane according to example embodiments has similar water permeability and salt rejection rate to a conventional CA film coated separation membrane but has a high molecular weight and thus high mechanical strength and overcomes weakness of a conventional cellulose polymer against microorganisms or an oxidizing agent, and thus may be appropriately used as a separation membrane.

While this disclosure has been described in connection with what is presently considered to be practical example embodiments, it is to be understood that the disclosed embodiments are not limiting, but, on the contrary, are intended to cover various modifications and equivalent arrangements included within the spirit and scope of the appended claims.

### DESCRIPTION OF SYMBOLS

10: separation membrane
11: active layer
12: supporting layer

What is claimed is:

1. A separation membrane, comprising:
a polymer including a structural unit represented by the following Chemical Formula 1 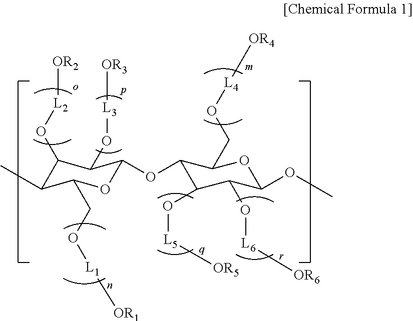
in the above Chemical Formula 1,
R₁ to R₆ are independently one selected from hydrogen, a substituted or unsubstituted C1 to C30 alkyl group, a substituted or unsubstituted C3 to C30 cycloalkyl group, a substituted or unsubstituted C3 to C30 heterocycloalkyl group, a substituted or unsubstituted C6 to C30 aryl group, a substituted or unsubstituted C6 to C30 heteroaryl group, a substituted or unsubstituted C7 to C30 alkylaryl group, a substituted or unsubstituted C7 to C30 arylalkyl group, and a —(C═O)R₇ group,
wherein R₇ is one selected from the substituted or unsubstituted C1 to C30 alkyl group, the substituted or unsubstituted C3 to C30 cycloalkyl group, the substituted or unsubstituted C3 to C30 heterocycloalkyl group, the substituted or unsubstituted C6 to C30 aryl group, the substituted or unsubstituted C6 to C30 heteroaryl group, the substituted or unsubstituted C7 to C30 alkylaryl group, and the substituted or unsubstituted C7 to C30 arylalkyl group,
provided that at least one of R₁ to R₃ and at least one of R₄ to R₆ are the same or different, and are the —(C═O)R₇ group, and
provided that at least one of R₁ to R₃ and at least one of R₄ to R₆ are the same or different, and are one selected from the substituted or unsubstituted C1 to C30 alkyl group, the substituted or unsubstituted C3 to C30 cycloalkyl group, the substituted or unsubstituted C3 to C30 heterocycloalkyl group, the substituted or unsubstituted C6 to C30 aryl group, the substituted or unsubstituted C3 to C30 heteroaryl group, the substituted or unsubstituted C7 to C30 alkylaryl group, and the substituted or unsubstituted C7 to C30 arylalkyl group,
L₁ to L₆ are independently one selected from a substituted or unsubstituted C1 to C30 alkylene group, a substituted or unsubstituted C3 to C30 cycloalkylene group, a substituted or unsubstituted C3 to C30 heterocycloalkylene group, a substituted or unsubstituted C6 to C30 arylene group, a substituted or unsubstituted C6 to C30 heteroarylene group, a substituted or unsubstituted C7 to C30 alkylarylene group, and a substituted or unsubstituted C7 to C30 arylalkylene group,
n and m are independently integers ranging from 0 to 150,
o, p, q, and r are independently integers ranging from 0 to 100, and
the polymer has a degree of substitution (DS) of the —(C═O)R₇ group equal to, or greater than, about 0.5 per anhydrous glucose unit.

2. The separation membrane of claim 1, wherein,
the polymer has a DS of the —(C═O)R₇ group ranging from about 0.5 to about 2.5 per anhydrous glucose unit, and
R₁ to R₆ are one selected from an alkyl group, a cycloalkyl group, a heterocycloalkyl group, an aryl group, a heteroaryl group, an alkylaryl group, and an arylalkyl group.

3. The separation membrane of claim 1, wherein the polymer has a weight average molecular weight ranging from about 50,000 to about 300,000.

4. The separation membrane of claim 1, wherein the separation membrane is a non-porous dense membrane.

5. The separation membrane of claim 1, wherein the separation membrane is permeable to water and impermeable to a salt.

6. The separation membrane of claim 1, wherein the separation membrane has a salt rejection rate ranging from about 50% to about 99.9%.

7. The separation membrane of claim 1, wherein the separation membrane forms a contact angle ranging from about 50° to about 65° with water.

8. The separation membrane of claim 1, wherein the separation membrane has a thickness ranging from about 0.01 μm to about 10 μm.

9. A composite separation membrane, comprising:
the separation membrane according to claim 1; and
a supporting layer supporting the separation membrane.

10. The composite separation membrane of claim 9, wherein the supporting layer has a porosity ranging from about 50 to about 80 volume % of the supporting layer.

11. The composite separation membrane of claim 9, wherein,
the separation membrane is a dense membrane, and
the dense membrane is laminated on at least one side of the supporting layer.

12. The composite separation membrane of claim 9, wherein the supporting layer comprises at least one selected from a polyacrylate-based compound, a polymethacrylate-based compound, a polystyrene-based compound, a polycarbonate-based compound, a polyethylene terephthalate-based compound, a polyimide-based compound, a polybenzimidazole-based compound, a polybenzthiazole-based compound, a polybenzoxazole-based compound, a polyepoxy-based resin compound, a polyolefin-based compound, a polyphenylenevinylene compound, a polyamide-based compound, a polyacrylonitrile-based compound, a polysulfone-based compound, a cellulose-based compound, polyvinylidene fluoride (PVDF), polytetrafluoroethylene (PTFE), and a polyvinylchloride (PVC) compound.

13. The composite separation membrane of claim 9, wherein the composite separation membrane is configured to be implemented a reverse or forward osmosis water treatment device.

14. A water treatment device, comprising:
the separation membrane according to claim 1.

15. The water treatment device of claim 14, wherein the water treatment device is configured to treat both fresh water and sea water.
